(19) United States
(12) Patent Application Publication
(10) Pub. No.: US 2010/0293095 A1
(43) Pub. Date: Nov. 18, 2010

(54) Method for Secure Identification of a Device

(76) Inventors: Christopher Alan Adkins, Lexington, KY (US); Stephen Porter Bush, Richmond, KY (US); John Yeung Conway, Louisville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/467,389

(22) Filed: May 18, 2009

(51) Int. Cl. H04L 9/30; G06Q 30/00

(52) U.S. Cl. 705/50

(57) ABSTRACT

A method for securely identifying whether an end user owns a particular device from a manufacturer and is a valid participant in a promotion with a partner of the manufacturer. The method allows an end user to verify ownership of a particular device via a computer network and securely obtain promotion related information which enables the end user to participate in a given sales promotion with a retail partner of the manufacturer of the device.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of Disclosure

The present invention generally relates to a method for verifying ownership of a device. More particularly, the present invention relates to a method for verifying ownership of a computer hardware component via a computer network.

2. Description of the Related Art

To promote the sale of products, two or more companies will often partner with one another for various types of sales promotions. The sales promotions may increase demand for the products involved, thus resulting in increased revenue for both of the partners based on the sale of such products. Such a partnership may involve a manufacturer of a particular device and a retailer of the particular device or other products relating thereto. For example, a joint promotion may include a computer hardware manufacturer and a retailer of computer hardware products. Such a promotion may provide all customers having ownership of a particular type of printer with a discount on printer cartridges sold by the retailer. This type of promotion would have potential to benefit both companies by driving increased sales of both printers and the printing cartridges therefore.

Most of the sales promotions between a manufacturer and a retailer typically require the presentation of some type of proof of ownership of a particular product or device to be eligible for participation in the promotion. Such proof of ownership may be a sales receipt or proof of purchase removed from the product or device packaging. Retaining the proof of purchase from product packaging or the receipt from a particular purchase can be problematic as customers often lose or misplace hard copies of receipts or proofs of purchase.

Online certificates printed from websites may also be used to establish eligibility for a customer to participate in a particular sales promotion. Online certificates may include a promotion ID number or other information regarding the sales promotion. The benefit provided by online certificates is that the certificates may be printed off at any time by the customer for use during the promotion. Since the online certificate can be printed at any time, the customer does not have to keep track of a hard copy which can be lost or misplaced. While online certificates provide some advantages, the online certificates can generally be printed by anyone regardless of ownership of a particular product. As a result, online certificates cannot be used to validate whether a customer is truly an owner of a certain product or device.

In view of the aforementioned deficiencies, there is a need in the art for an improved method of providing verification of ownership of a particular product or device for eligibility in a sales promotion.

### SUMMARY OF THE DISCLOSURE

Disclosed herein, is a method for the secure identification of a device via a computer network to allow the end user of the device to participate in a promotion conducted by the partner of the device manufacturer. The method may comprise authenticating the device via a secure server of the partner of the device manufacturer; providing a packet of encrypted promotion information from the secure server of the partner to the authenticated device; decrypting the packet of encrypted promotion information with the authenticated device; and converting the decrypted promotion information into a format that may be provided to the partner of the device manufacturer. The packet of encrypted promotion information may be encrypted by the secure server using a device public key to encrypt a packet of promotion information. The packet of encrypted information may be decrypted by the device using a device private key. The device may be a computer printer. The computer printer may print the packet of promotion information upon decrypting the packet of encrypted promotion information received from the secure server. Alternatively, the device may be a computer scanner, a computer hard drive, a digital camera, a media player, a cellular phone, or other computer related hardware.

The method for securely identifying the device by the secure server may comprise sending a challenge from the secure server to the device; generating a signature of the challenge with the device by signing the challenge with a device private key; sending the signature of the challenge, a device public key, and a signature of the device public key to the secure server, wherein the signature of the device public key is created with a manufacturer root private key; verifying the device public key with the secure server by verifying the signature of the device public key with a manufacturer root public key; and verifying the signature of the challenge with the secure server using the verified device public key.

The method for securely identifying the secure server by the device may comprise sending a random challenge from the device to the secure server; generating a signature of the challenge with the secure server by signing the challenge sent to the secure server with the secure server private key; sending the signature of the challenge generated by the secure server and the secure server public key to the device; verifying the secure server public key; and verifying the signature of the challenge with the device using the verified secure server public key. The secure server public key may be verified by the device by retrieving a secure server signed public key from the secure server of the device manufacturer and verifying the secure server signed public key with a manufacturer root public key. The secure server signed public key may be generated by signing the secure server public key with a manufacturer root private key. Alternatively, the secure server signed public key may be sent to the device from the secure server with the signature of the challenge generated by the secure server and the secure server public key. Once the device receives the secure server signed public key, the signature of the challenge and the secure server public key, the device may verify the secure server public key using a manufacturer root public key. The signed public key may be generated by the device manufacturer and sent to the partner's secure server prior to authentication of the secure server.

### BRIEF DESCRIPTION OF THE DRAWINGS

FIG. 1, is a flowchart showing the general process of verifying ownership of a device and providing promotion information in accordance with the present invention.

FIG. 2, is a flowchart showing the initial keying of a device during the device manufacturing process in accordance with the present invention.

FIG. 3, is a flowchart showing a procedure utilized by a secure server to authenticate a device in accordance with the present invention.

FIG. 4a, is a flowchart showing the procedure for verification of a partner's secure server via a device in accordance with the present invention.

FIG. 4b, is a flowchart showing an alternative embodiment of the procedure for verification of a partner's secure server via a device in accordance with the present invention.

FIG. 5, a flowchart showing a procedure for a dual authentication process in accordance with the present invention.

FIG. 6, is a flow chart showing the procedure for transmitting encrypted promotion information from a partner's secure server to a device in accordance with the present invention.

### DETAILED DESCRIPTION

In accordance with the present invention there is provided a method for securely identifying whether an end user owns a particular device from a manufacturer and is a valid participant in a promotion with a partner of the manufacturer. The method allows an end user to verify ownership of a particular device via a computer network and securely obtain promotion related information which enables the end user to participate in a given sales promotion with a retail partner of the manufacturer of the device. The promotion related information may include an ID redemption code and/or other information in relation to a sales promotion. The promotion related information may be in the form of an online certificate that may be provided to the retail partner to be eligible for a particular sales promotion. This method eliminates the need for retaining hard copies of receipts or proofs of purchase by the end user of a particular device to be eligible to participate in a sales promotion related to the particular device.

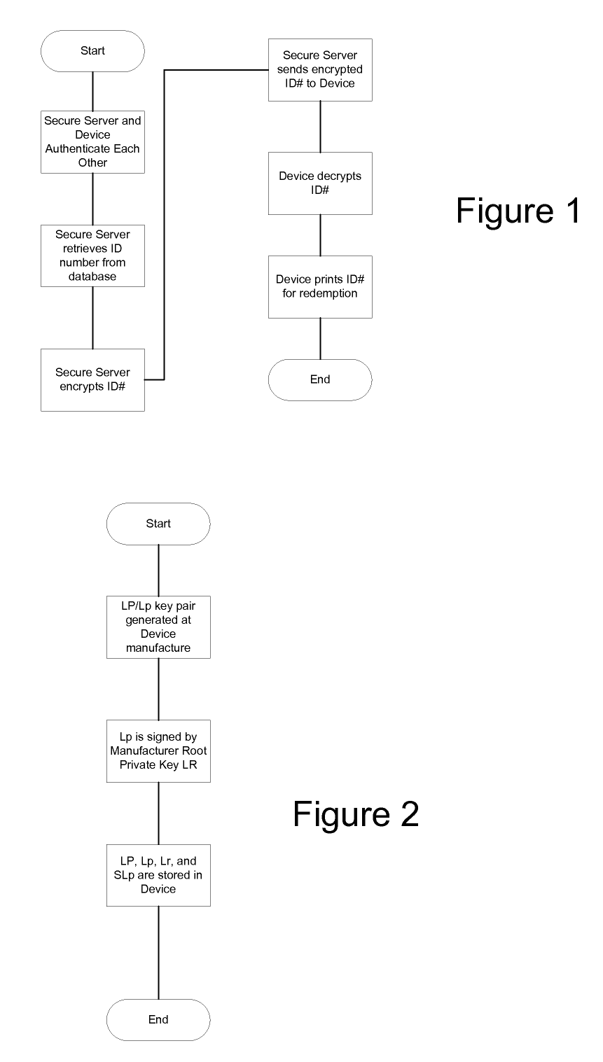

Shown in FIG. 1 is a flowchart outlining the general process of securely verifying ownership of a device by an end user and providing the end user with promotion related information. To verify ownership of a particular device, the device may be first authenticated by a retail partner's secure server, and, if necessary, the retail partner's secure server may be authenticated by the device. To be authenticated by the partner's secure server and to authenticate the partner's secure server, the device must have the ability to communicate with the partner's secure server. The device may communicate with the partner's secure server via the internet, a phone line, or a private network. The partner's secure server may also utilize a website as the front end to enable communication via the internet. As such, the device may include, or be connected with the necessary hardware for communication with the partner's secure server such that the device may send information to and receive information from the partner's secure server. For example, the device may be a computer printer having the capability to communicate with the partner's secure server via hardware contained therein or hardware to which it is connected. This authentication can occur via any number of common cryptographic protocols. Examples of common asymmetric cryptographic protocols include, but are not limited to RSA® and elliptical curve cryptography (“ECC”). Examples of common symmetric cryptographic protocols include, but are not limited to Advanced Encryption Standard (“AES”), Data Encryption Standard (“DES”), and Triple Data Encryption Standard (“Triple-DES”).

Once the authentication of the device by the partner's secure server and/or authentication of the partner's secure server by the device has taken place, the partner's secure server retrieves promotion related information and encrypts the information. The encrypted information is then sent to the device or hardware connected thereto. The promotion related information may include a unique redemption code and/or other information in relation to a sales promotion involving the device manufacturer and a retail partner of a manufacturer. The device or computer hardware in connection therewith then receives and decrypts the encrypted information. The encryption and decryption may be accomplished via any number of common cryptographic protocols, such as RSA®, ECC, AES, DES, or Triple-DES. The decrypted information may be provided in electronic or hard copy which may be provided to the partner of the device manufacturer. The decrypted information may be in the form of a certificate that can be printed and provided by the end user to the partner of the device manufacturer. The user may provide the online certificate to the partner by whatever mechanism the partner requires (e.g., through a brick-and-mortar store, website, mail-in, etc).

Shown in FIG. 2 is a flow chart illustrating the initial keying of the device during the device manufacturing process. A key pair LP (device private key)/Lp (device public key) is generated for each device and is written to the device's memory (flash, NVRAM, etc.). The device may be a computer hardware component such as a printer, scanner, hard drive, etc. The device may also be an electronic component that may be used with a computer such as a digital camera, media player, or cellular phone. Also, a signature of the device's public key (SLp) is generated by signing the device public key (Lp) with manufacturer root private key LR. The key pair (LP/Lp), and the signature of the device public key (SLp) are then stored within the memory of the device. By storing the signature of the device public key within the memory of the device, the partner's secure server will be able to verify that the public key (Lp) presented to the secure server by the device is a valid manufacturer key. In addition, if there is intent for the device to be able to authenticate the partner's secure server, the manufacturer root public key (Lr) may also be written to the device memory. This will allow the device to verify parameters that are signed by the manufacturer (like the partner's public key) if necessary.

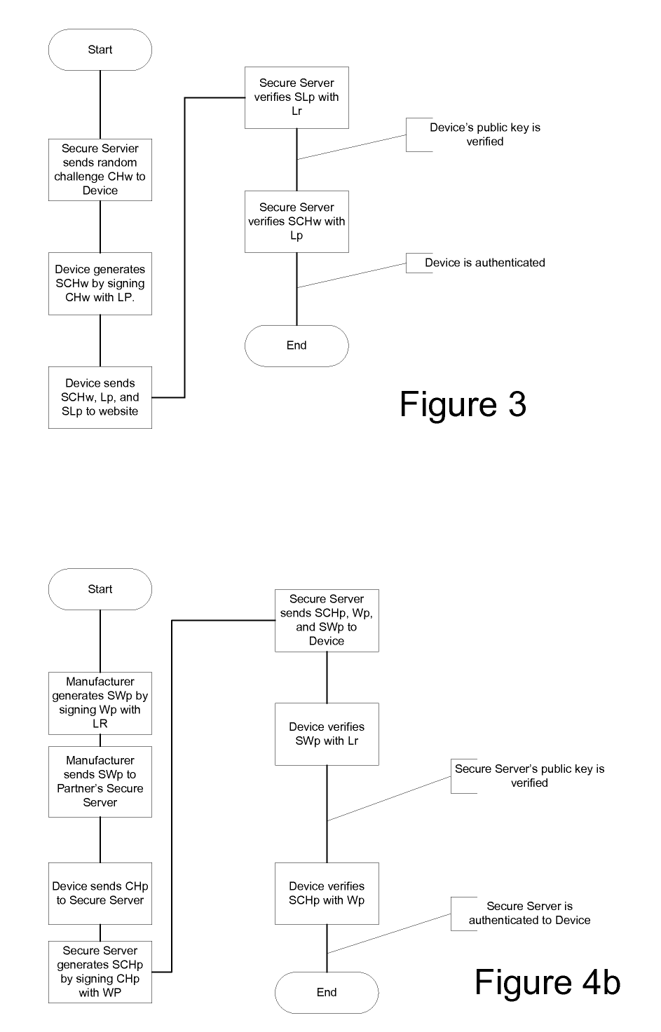

Shown in FIG. 3 is a flowchart illustrating a procedure utilized by a partner's secure server to authenticate the device. To authenticate the device, the partner's secure server first sends a random challenge (CHw) to the device. The device then generates a signature of the challenge (SCHw) by signing the challenge (CHw) with the device private key (LP). The device then sends the signature of the challenge (SCHw), the device public key (Lp) and a signature of the device public key (SLp) created with the manufacturer root private key to the partner's secure server. The partner's secure server verifies the signature of the device public key (SLp) with the manufacturer root public key (Lr) to verify the device public key (Lp). The secure server then verifies the signature of the challenge (SCHw) with the device public key (Lp) to authenticate the device.

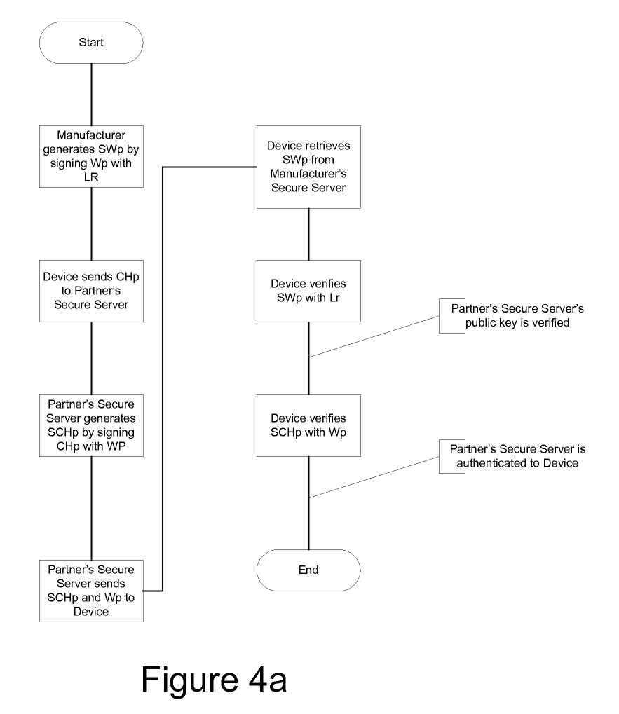

Shown in FIG. 4a is a flowchart illustrating how the device may verify a secure server of the partner of the device manufacturer using a Public Key Infrastructure (PKI) scheme involving public/private key pairs. This process may be useful for preventing the generation of fraudulent redemption certificates from potential adversaries of the partner of the device manufacturer. For this process, the device manufacturer generates a signature of the secure server public key (SWp) by signing the secure server public key (Wp) with the manufacturer root private key (LR). The signature of the secure server public key is then stored in a database by the device manufacturer. To verify the partner's secure server, the device sends a random challenge (CHp) to the partner's secure server which is presumably operated by the partner of the manufacturer. The partner's secure server then returns a signature of the challenge (SCHp) to the device which is generated by signing the challenge (CHp) sent to the partner's secure server with the secure server private key (WP). The secure server public key (Wp) is sent with the signature of the challenge (SCHp) to the device. The device then retrieves the signature of the secure server public key (SWp) from a secure manufacturer server via a secure connection. The device may communicate with the manufacturer secure server via the internet, a phone line, or a private network. The manufacturer secure server may utilize a website as a front end to enable the communication via the internet. The device verifies the signature of the secure server public key (SWp) using the manufacturer root public key (Lr) to verify the secure server's public key (Wp). Once the secure server's public key (Wp) is verified, the device uses the secure server public key (Wp) to verify the secure server's signature of the challenge (SCHp) to authenticate the secure server.

Shown in FIG. 4b, is a flowchart illustrating an alternative to the process shown in FIG. 4a for verifying the secure server of a partner of the manufacturer. As shown in FIG. 4b, the device manufacturer generates a signature of a secure server public key (SWp) by signing the secure server public key (Wp) with the manufacturer root private key (LR). The signature of the secure server public key (SWp) is then sent to the secure server of a partner of the device manufacturer. The device may then send a random challenge (CHp) to the partner's secure server. The partner's secure server generates a signature of the challenge (SCHp) by signing the challenge (CHp) with the secure server private key (WP). The secure server then sends the signature of the challenge (SCHp), the secure server public key (Wp), and the partner's secure server signed public key (SWp) to the device. The device then verifies the secure server signed public key (SWp) using the manufacturer root public key (Lr) which provides verification of the secure server public key (Wp). The device then verifies the signature of the challenge (SCHp) with the secure server's public key (Wp) to authenticate the partner's secure server. This process requires only one external connection from the device to the partner's secure server. A connection to the manufacturer's secure server is not necessary. This process may be used in situations wherein the partner's key revocation status is not an issue as it may be difficult to determine whether the partner's public key (Wp) has been revoked.

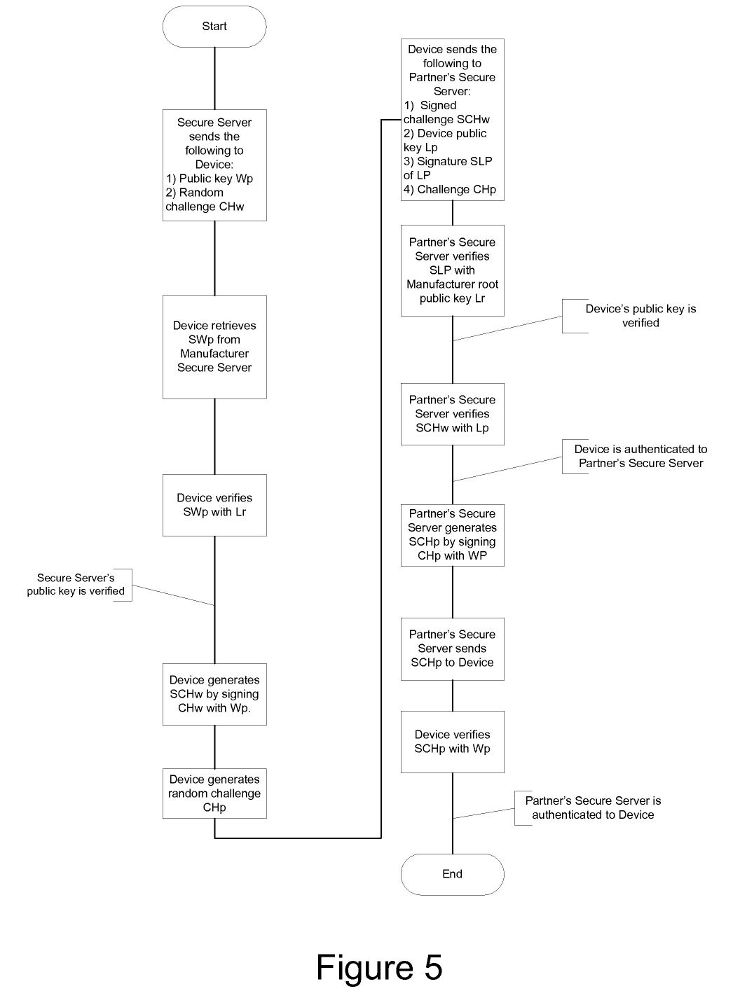

Shown in FIG. 5, is a flowchart illustrating a dual authentication process, wherein the processes shown in FIGS. 3 and 4 are combined into one session where the appropriate challenges, keys, and signatures are exchanged to authenticate the device by the partner's secure server and to authenticate the partner's secure server by the device. In this process, the partner's secure server sends a secure server public key (Wp) and a random challenge (CHw) to the device. The device then retrieves a signature of the secure server public key (SWp) from the manufacturer's secure server via a secure connection. The device then verifies the signature of the secure server public key (SWp) with the manufacturer root public key (Lr) to verify the secure server public key (Wp). The device then generates a signature of the challenge (SCHw) by signing the challenge from the secure server (CHw) with the secure server public key (Wp). The device then generates a random challenge (CHp). The signed challenge from the secure server (SCHw), the device public key (Lp), a signature of the device private key (SLP), and the random challenge (CHp) from the device are sent to the partner's secure server. Upon receipt of the signature of the device private key (SLP), the secure server verifies the signature of the device private key (SLP) with the manufacturer root public key (Lr) to verify the device public key (Lp). The secure server then verifies the signature of the secure server challenge (SCHw) with the device public key (Lp) to authenticate the secure server. Upon authentication of the partner's secure server, the partner's secure server generates a signature of the device challenge (SCHp) by signing the device challenge (CHp) with the secure server private key (WP). The partner's secure server then sends the signed device challenge (SCHp) to the device for authentication. Upon receipt of the signed device challenge (SCHp) by the device, the device verifies the signed device challenge (SCHp) with the secure server public key (Wp) to authenticate the partner's secure server.

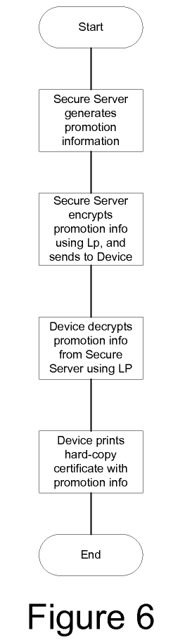

Shown in FIG. 6 is a flow chart illustrating the encrypted transmission of the promotion information from the partner's secure server to the device, after the device has been authenticated by the secure server. The promotion information may include a redemption ID code and/or other information in relation to the promotion by the partner of the device manufacturer. The secure server first generates the promotion information to be sent to the device. The secure server encrypts the promotion information with the device public key Lp, and sends the encrypted promotion information to the device. The device receives the encrypted information and decrypts the encrypted information with the device private key (LP). Once decrypted, the promotional information may be received from the device. The promotional information received from the device may be in electronic or hard copy form such that it may be provided by the end user to the partner of the manufacturer. In the case of the device being a computer printer, the printer may print a hard copy of the promotion information upon decrypting the promotion information received from the partner's secure server. The hard copy of the promotion information may be in the form of a certificate.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

What is claimed is:

1. A method for participating in a promotion using an electronics device, the method comprising:
establishing communication between said device and a secured server over a network;
authenticating one of said device and the server;
following authenticating, receiving by said device a packet of encrypted promotion information from the secured server;
decrypting said packet of encrypted promotion information with said device; and
converting said packet of decrypted promotion information into a format that may be redeemed in accordance with the promotion information.

2. The method according to claim 1, wherein the authenticating comprises authenticating the device, comprising:
receiving a challenge from the secure server by said device;
generating a signature of said challenge with said device by signing said challenge with a device private key; and
sending said signature of said challenge, a device public key, and a signature of said device public key to the secure server, wherein said signature of said device public key is based on a root private key corresponding to one of the device and a manufacturer thereof.

3. The method according to claim 2, wherein the authenticating further comprises:
verifying said device public key by verifying said signature of said device public key with a manufacturer root public key; and
verifying said signature of said challenge using said verified device public key.

4. The method according to claim 1, wherein authenticating comprises authenticating the secure server with said device, comprising:
sending a challenge from said device to the secure server;
in response, receiving from the secure server a signature of said challenge based on a private key of the secure server, a secure server public key from the secure server and a secure server signed public key;
verifying said secure server public key with said device by verifying said secured server signed public key with a manufacturer root public key; and
verifying said signature of said challenge with said device using said verified secure server public key.

5. The method according to claim 1, wherein authenticating comprises authenticating the secure server, comprising:
sending a challenge from said device to the secure server;
in response, receiving a signature of said challenge, a server public key, and a secure server signed public key to said device, wherein said secure server signed public key is generated by signing said secure server public key with a manufacturer root private key;
verifying said secure server signed public key with said device using a manufacturer root public key to provide verification of said secure server public key; and
verifying said signature of said challenge with said device using said verified secure server public key.

6. The method according to claim 5, wherein said signed public key is generated by the device manufacturer and sent to the secure server prior to authentication of the secure server.

7. The method according to claim 1, wherein said packet of encrypted promotion information is encrypted by the secure server using a device public key.

8. The method according to claim 1, wherein said packet of encrypted information is decrypted by said device using a device private key.

9. The method according to claim 1, wherein said device is a printer.

10. The method according to claim 9, wherein said printer prints said decrypted packet of promotion information upon decrypting said packet of encrypted promotion information received from the secure server.

11. The method according to claim 1, wherein said device is selected from the group consisting of a computer scanner, a computer hard drive, a digital camera, a media player, and a cellular phone.

12. A method, comprising:
sending a challenge from a device to a secure server over a network;
receiving at the device a signature of said challenge and a secure server public key, the signature of said challenge being based upon a private key of the secure server;
verifying said secure server public key; and
verifying said signature of said challenge with said device using said verified secure server public key.

13. The method according to claim 12, further comprising:
receiving a second challenge at the device from the secure server;
generating a signature of said second challenge by signing said second challenge with a device private key; and
sending to the secure server the signature of said second challenge, a device public key and a signature of said device public key to the secure server, wherein said signature of said device public key is created with a root public key.

14. The method according to 12, wherein verifying said secure server public key comprises retrieving a secure server signed public key and verifying said secure server signed public key with a manufacturer root public key.

15. The method according to claim 14, wherein said secure server signed public key is generated by signing the secure server public key with a manufacturer root private key.

16. The method according to claim 12, further comprising receiving a secure server signed public key from the secure server with said signature of said challenge and said secure server public key.

17. The method according to claim 16, wherein verifying said secure server public key comprises verifying the secure server signed public key with said device using a manufacturer root public key.

18. The method according to claim 16, wherein said secure server signed public key is generated by signing the secure server public key with a manufacturer root private key.

19. The method according to claim 16, wherein said secure server signed public key is generated by the device manufacturer and sent to the secure server prior to authentication of the secure server.

20. The method according to claim 12, further comprising:
following verifying said signature of said challenge, receiving by the device a packet of encrypted promotion information from the secure server;
decrypting said packet of encrypted promotion information with said device; and
converting said packet of decrypted promotion information into a format that may be redeemed in accordance with the promotion information.
